(19) United States
(12) Patent Application Publication
(10) Pub. No.: US 2005/0121617 A1
(43) Pub. Date: Jun. 9, 2005

(54) Radiation detector, as well as a method for synchronized radiation detection

(76) Inventors: Bjoern Heismann, Erlangen (DE); Thomas Reichel, Heroldsbach (DE)

Correspondence Address: HARNESS, DICKEY & PIERCE, P.L.C., P.O.BOX 8910, RESTON, VA, 20195, US

(21) Appl. No.: 11/006,758

(22) Filed: Dec. 8, 2004

(30) Foreign Application Priority Data
Dec. 8, 2003 (DE) DE 103 57 202.3

(51) Int. Cl. G01T 1/24

(52) U.S. Cl. 250/370.11

(57) ABSTRACT

A radiation detector and a method are for synchronized radiation detection. The radiation detector has a two-dimensional arrangement of radiation sensors using APS technology, and evaluation electronics with an input for a synchronization signal. The evaluation electronics have two or more free-running current/frequency converters for conversion of analog signals from the radiation sensors to digital signals. A correction unit is also provided for correction of errors in the digital signals which are caused by time discrepancies in a nominal time period, which is predetermined by the synchronization signal, for detection of the radiation from conversion events of the free-running current/frequency converters. The radiation detector can be produced at low cost, and allows simplified and scalable modular construction.

The present application hereby claims priority under 35 U.S.C. §119 on German patent application number DE 103 57 202.3 filed Dec. 8, 2003, the entire contents of which are hereby incorporated herein by reference.

### FIELD OF THE INVENTION

The present invention generally relates to a radiation detector for synchronized radiation detection. Preferably, it relates to one which has a two-dimensional arrangement of radiation sensors using APS technology, and evaluation electronics with an input for a synchronization signal, which are arranged on or at a mount substrate, or are integrated in a mount substrate. The invention also generally relates to a method for synchronized detection of radiation, in particular of X-ray radiation. Preferably, the method includes having a two-dimensional arrangement of radiation sensors using APS technology, in which analog signals from the radiation sensors are converted to digital signals.

### BACKGROUND OF THE INVENTION

Radiation detectors as well as methods of the stated type can be used in many technical fields for radiation detection, for example of optical radiation or X-ray radiation. One important field of application for radiation detectors relates to X-ray technology, for example the fields of medical X-ray technology, material inspection or safety technology. In these fields, problems are occurring increasingly as the number of measurement channels of the detectors increases, as will be explained in more detail in the following text with reference to X-ray computer tomography (X-ray CT).

X-ray detectors in X-ray CT systems have been subject to an enormous increase in the number of measurement channels in recent years. While single-line X-ray detectors with about 700 measurement channels, that is to say with 700 detector elements arranged in one line with the associated wiring and reading electronics, were used a few years ago, 16-line X-ray CT systems with a correspondingly greater number of measurement channels are already in clinical use nowadays. This development will continue in the coming years.

Typical X-ray detectors are in this case composed of a two-dimensional array of photosensors, which are covered by scintillators in order to convert the incident X-ray radiation to light radiation, and are connected to separately arranged evaluation electronics. As a result of the further increase in the number of measurement channels, the number of previously required connections between the photosensors and the electronics is becoming so great that classic design technologies are reaching their limits. Furthermore, the costs which are incurred for each measurement channel cannot easily be reduced by greater integration of the electronic without problems, as will be necessary in order to maintain constant overall costs for the electronics.

U.S. Pat. Nos. 5942775A and 5887049A each disclose X-ray detectors which use a two-dimensional arrangement of photosensors using APS technology. These APS arrays can be produced using CMOS technology and allow low-cost greater integration of the photosensors, in which case the evaluation electronics can also be integrated together with the photosensors in a mount substrate.

WO 98/56214 A1 describes an X-ray detector with a two-dimensional arrangement of photosensors using APS technology, which are integrated together with evaluation electronics in a mount substrate. The evaluation electronics in this case, in one refinement, also comprise an analog/digital converter for conversion of the analog signals from the photosensors to digital signals, so that this X-ray detector produces digital signals directly.

As a rule, a synchronization input is provided on the X-ray detector for the synchronization which is required for X-ray CT systems, with the arrival of a synchronization signal marking the end of the previous measurement interval, and the start of the next measurement interval. The mean intensity of the photosensor signal between two successive synchronization signals provides a measure for the digital signal, which is then read.

In one embodiment, the last-mentioned document also describes a technique in which the photosensors are read using a fixed clock frequency, without external synchronization. By comparison of the values of two respective successive time windows, which are predetermined by the clock frequency, the arrival of the X-ray radiation can be identified, and the magnitude can be determined by further processing of the values detected in these time windows. The clock frequency is in this case chosen such that the duration of one X-ray pulse is shorter than the duration of two time windows.

Despite the implementation of radiation detectors with APS arrays and the advantages associated with them, there is still a need for radiation detectors, in particular X-ray detectors, for synchronized radiation detection, which can be produced cost-efficiently. There is also a desire to reduce the number of connections required in the detector.

### SUMMARY OF THE INVENTION

It is an object of an embodiment of the present invention to specify a radiation detector as well as a method for synchronized detection of radiation, in particular of X-ray radiation, which allow cost-effective production of the detector and a reduction in the connections required in the detector.

An object of an embodiment may be achieved by a radiation detector and by a method for synchronized detection of radiation. Advantageous refinements of the radiation detector and of the method will become evident from the following description as well as the exemplary embodiments.

The present radiation detector for synchronized radiation detection has a two-dimensional arrangement of radiation sensors using APS technology, and evaluation electronics with an input for a synchronization signal, which are arranged on or at a mount substrate or are integrated in a mount substrate. The evaluation electronics in this case comprise two or more analog/digital converters for conversion of analog signals from the radiation sensors to digital signals.

In the present radiation detector, these analog/digital converters are in the form of free-running and thus untriggered current/frequency converters, which continuously convert the current supplied from the photosensors during operation. Since these converters operate on a free-running basis, time discrepancies occur in the nominal time period, which is predetermined by the synchronization signal, for detection of the radiation from the conversion events in the free-running current/frequency converters, and these lead to errors or inaccuracies in the digital signals. In order to correct these errors, the present radiation detector has an additional correction unit, which corrects the errors on the basis of the time information which is supplied from the converters for the individual conversion events.

In this case, a separate current/frequency converter is preferably arranged on or at the mount substrate for each individual radiation sensor, that is to say in the immediate physical vicinity of each radiation sensor, or is integrated in the mount substrate, and is connected to the radiation sensor for signal conversion. The digital signals can then be transmitted in serial form via one or more multiplexers on a small number of transmission lines.

In the case of current/frequency converters as are used for the present radiation detector, the current to be converted or the voltage to be converted is converted to a sequence of square-wave pulses. For this purpose, the input current is integrated until the output voltage of the integrator has reached the level of a comparison voltage. A defined amount of charge is then extracted, and a square-wave pulse is produced. After this conversion event, a new conversion process starts. The time interval between two successive pulses in the pulse sequence that is produced is thus a measurement of the mean input current between these two pulses.

In the case of the present radiation detector, two or more analog/digital converters are thus arranged together with the photosensors on or at the mount substrate or are integrated in the mount substrate, so that signal paths between the photosensors and the analog/digital converters can be reduced or even minimized. In an exemplary embodiment, each detector element is formed by a photosensor with the associated analog/digital converter as well as the necessary wiring and, if required, further circuit parts of the evaluation electronics. The entire detector may in this case be manufactured using CMOS technology, as is known from APS arrays in the prior art.

One major advantage of the radiation detector of an embodiment of the present invention is the use of the free-running current/frequency converters, which are not used, for system reasons, for synchronized applications in the prior art. The synchronization problems are overcome with the detector of an embodiment, however, by the use of the correction unit, which carries out calculations to correct the inaccuracies which are caused by time discrepancies in the nominal time period, which is predetermined by the synchronization signal, for detection of the radiation from the conversion events in the free-running current/frequency converters. This allows the synchronized radiation detection accuracy to be achieved as is also the case with the normally used triggered analog/digital converters.

The use of the free-running current/frequency converters with the associated correction unit additionally has considerable advantages, however. For example, their use leads to less stringent accuracy requirements for the production process for the electronics for the radiation detector, since current/frequency converters based on the conversion principle on the one hand require fewer circuit parts and on the other hand, for example, do not require high-precision manufacture of their components. Furthermore, in the case of the present radiation detector, the free-running converter principle means that there is no charging time limit, integration time limit or dead time, thus resulting in optimum quantum utilization. The transmission characteristic of this converter principle results in non-equidistant quantization, in which the quantization steps are small for small input signals and are large for large input signals. This is an excellent behavior for satisfaction of the requirements to which radiation detectors are subject.

The possible combination of the radiation sensors, of the electronics and of the correction unit in one component allows high cost-efficiency to be achieved, since the area which is required for each detector element can be optimally utilized by way of vertical integration, for example using a silicon wafer as the mount substrate. The digital output of each individual detector element as well as of each group of detector elements, and the multiplexing which this makes possible results in a considerable reduction in the output lines that are required, so that the modular design of a radiation detector such as this in two dimensions, as well as its scaling, are considerably simplified.

In one refinement, the present radiation detector of one embodiment is in the form of an X-ray radiation detector, for example for X-ray CT systems. In this case, the radiation sensors are photosensors, above which scintillators are arranged in order to convert incident X-ray radiation to light radiation. The scintillators in this case preferably cover not only the photosensitive surfaces of the photosensors, but also further subareas between the photosensitive surfaces, so that this results on the one hand in covered subareas and on the other hand in uncovered subareas on the X-ray detector.

The individual detector elements are in this case designed such that digital circuit parts and wiring for the evaluation electronics are essentially arranged under the uncovered subareas, while analog circuit parts for the evaluation electronics are essentially arranged under the areas which are covered by the scintillators. The uncovered subareas are in this case used in a known manner for optical isolation between the individual detector elements, although, of course, intermediate walls (which may, for example, form a collimator) may also be arranged in these subareas.

The analog circuit parts, which are more sensitive to X-ray radiation, are positioned under the subareas which are covered by the scintillators, since the scintillators allow only a small proportion of the X-ray radiation to pass through them. A refinement of the radiation detector such as this makes it possible to produce X-ray detectors which are very highly suitable for multiple channel systems in X-ray CT, or else in the field of other other X-ray absorption methods, such as material inspection and safety technology. This also applies, of course, to the associated method for synchronized detection of the radiation.

### BRIEF DESCRIPTION OF THE DRAWINGS

The present radiation detector as well as the method on the basis of which it operates will be explained once again in the following text using an exemplary embodiment and in conjunction with the drawings, in which:

FIG. 1 shows an example of the basic cell of the radiation detector of an embodiment of the present invention;

FIG. 2 shows a schematic illustration of an evaluation channel in the radiation detector of an embodiment of the present invention;

FIG. 3 shows an example of a timing diagram for current/frequency conversion with an embodiment of the present radiation detector; and

FIG. 4 shows a block diagram of the recursive correction algorithm which is used.

### DETAILED DESCRIPTION OF THE EXEMPLARY EMBODIMENTS

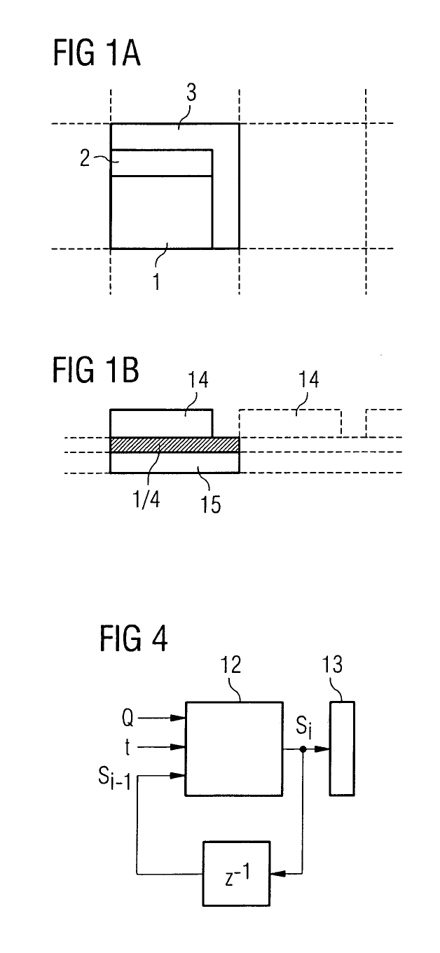

FIG. 1 shows an example of a basic cell of an (Active Pixel Sensor) APS measurement pixel in the form of a side view (FIG. 1b) and a plan view (FIG. 1a), as is used as the detector element in the present radiation detector. The radiation detector in this case includes a pixel matrix with m×n pixels (a section of which is indicated by dashed lines in the figure), which are produced on a CMOS silicon wafer as the mount substrate 15, with m and n preferably being greater than 10. The basic cell, which is illustrated by solid lines in FIG. 1, can be subdivided into three areas.

The first area includes the photosensitive area of the photosensor 1, which converts the incident light radiation to current. A structured scintillator 14 is arranged above the matrix of these basic cells, for conversion of X-ray radiation to visible light. Suitable scintillator materials are known to those skilled in the art, for example from the documents cited in the introduction to the description. The silicon wafer, which is used as the mount substrate 15, is subjected to different X-ray loads by the structuring of the scintillator material, by which individual scintillators 14 are formed, which are associated with the photosensors 1.

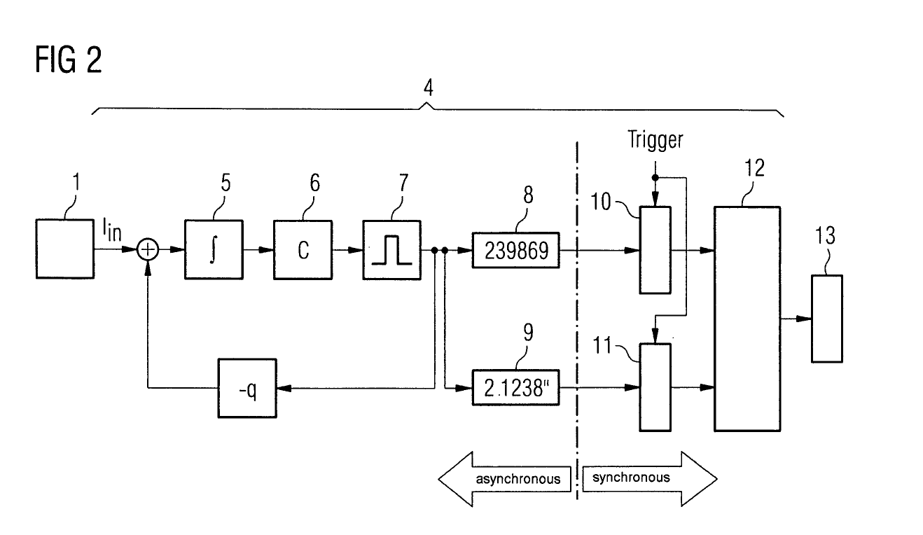

Areas with scintillator material above them receive only about 1/15 of the dose comparison to the rest of the surface. Since the CMOS electronics have different radiation sensitivity depending on the purpose of the circuit, the scintillator 14 is designed, arranged and structured such that a subarea 2 alongside the photosensitive area of the photosensor 1 is also covered. Those circuit parts which are more sensitive to radiation are arranged in this subarea 2. These are preferably the analog circuit parts of the evaluation circuit (which is illustrated in FIG. 2 to the left of the separating line that is shown).

In the remaining area 3, which is not covered by the scintillator, only a reflector layer through which radiation can pass attenuates the primary X-ray radiation. Digital circuit parts and wiring are positioned here in a corresponding manner. The overall dimensions of a basic cell such as this are generally (1 . . . 10)×(1 . . . 10) mM², with the lateral extent of the individual areas each being ≦300 μm.

FIG. 2 shows, schematically, the evaluation electronics, which are arranged in the areas 2 and 3, for an evaluation channel. The separating line which is shown in this case indicates the subdivision into the asynchronous circuit part in the left-hand section and the synchronous circuit part including the correction unit in the right-hand section of the figure.

The asynchronous part is completely fitted on or to the mount substrate, or is integrated in the mount substrate. The synchronous part may also be provided entirely, or in parts of it, outside the mount substrate. The current signal which is received from the photosensor 1 is converted by the current/frequency converter 4 to a sequence of pulses, whose frequency corresponds to the magnitude of the current signal. The architectures of current/frequency converters such as these are known from the prior art.

The converter 4 includes an asynchronous part with the integrator 5, the comparator 6, the pulse former 7, the counter 8 and the time stamp generator 9, as well as a synchronous part with the Q register 10 and a t register 11, which provide the time marking t and the count Q at defined trigger times. The asynchronous part in essence represents a free-oscillating, current-controlled oscillator. The two counts, which are stored in the registers 10 and 11, are used as input variables for the correction unit 12, which produces as the result 13 the value of a mean current which is related to the original synchronous trigger interval, that is to say a corrected mean current.

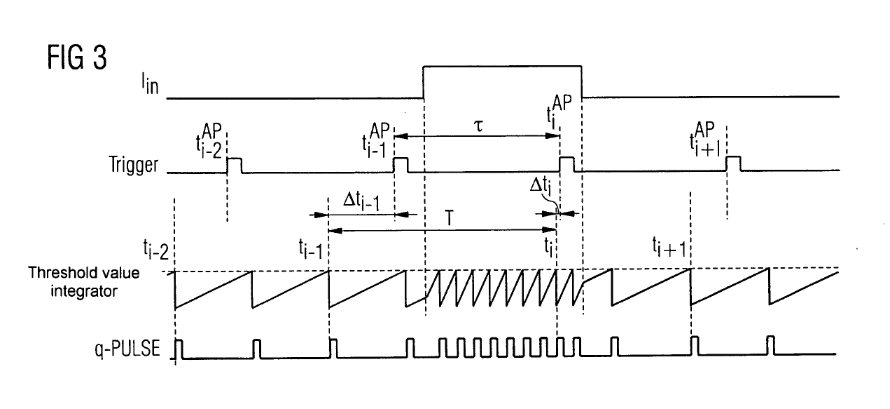

FIG. 3 shows the signal timings during use of the present radiation detector, related to the evaluation channel shown in FIG. 2. The uppermost curve (Iᵢₙ) represents, by way of example, the profile of the input signal received from the photosensor 1. The equidistant trigger signal is shown underneath this. The profile of the integrator output signal from the current/frequency converter 4 can be seen underneath the trigger signal. The lowermost curve shows the output signal of the pulse former 7 in the current/frequency converter 4.

The measurement variable of interest is the mean current which flows within the interval that is annotated τ. This corresponds, for example, to the intensity in the angle section of the CT revolution to be recorded. The current is given by I=ΔQ/ΔT, where ΔQ=Δn×q, q corresponds to the amount of charge per integration process or pulse from the pulse former 7, and Δn corresponds to the difference between the counts of two successive trigger processes (=read processes).

The current signal which is produced by the photosensor 1 is integrated by the integrator 5. As soon as the integrator reaches a specific threshold value, which is predetermined by the comparator 6, the pulse former 7 produces a pulse. In consequence, a defined amount of charge q is extracted from the integrator 5, and the cycle begins again. The frequency of the pulses is thus a measure of the magnitude of the input signal.

An increased input signal can now be seen in the central area in the uppermost curve in the figure caused, for example, by the X-ray intensity being stronger at times. Exact detection of the input signal which arises within the trigger or synchronization interval τ is impossible owing to the free-running operation of the current/frequency converter 4, as can be seen from FIG. 3. Since the individual conversion events, that is to say the integration intervals for forming the individual pulses and thus the charge packets q, occur asynchronously with respect to the trigger interval, this results in a measurement interval T which is shifted relative to the position of the trigger interval T, as is indicated in the figure. This shift results in an error which is identified by Δtᵢ₋₁, or Δtᵢ, which leads to an inaccuracy in the digitized signals.

The error (explained in conjunction with FIG. 3) in the signals which have been digitized by the current/frequency converter 4 is corrected by calculation by the correction unit 12, which is indicated in FIG. 2. The recursive correction algorithm which is used in this case is:

$${S}_{i} = \frac{Δ n τ - {S}_{i - 1} Δ {t}_{i - 1}}{τ - Δ {t}_{i}}$$

where τ corresponds to the trigger interval (nominal time period), Sᵢ to the instantaneous (corrected) digital signal, Sᵢ₋₁ to the immediately preceding (corrected) digital signal, Δn to a difference in the count of the current/frequency converter between the instantaneous signal and the immediately preceding signal, Δtᵢ₋₁ to the time difference between the start of the nominal time period and the start of the immediately preceding conversion event, and Δtᵢ to the time difference between the end of the nominal time period and the start of the immediately subsequent conversion event.

The instantaneous Sᵢ is calculated from the input variables Δn and t and from the preceding result Sᵢ₋₁ using this correction algorithm, as is illustrated, once again in schematic form, in FIG. 4. The correction unit itself may in this case optionally be integrated directly on the mount substrate or in a downstream unit.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A radiation detector for synchronized radiation detection, comprising:
a two-dimensional arrangement of radiation sensors using APS technology; and
evaluation electronics with an input for a synchronization signal, at least one of arranged on or at a mount substrate and integrated in a mount substrate, wherein the evaluation electronics include,
at least two free-running current/frequency converters for conversion of analog signals from the radiation sensors to digital signals, and
a correction unit for correction of errors in the digital signals, caused by time discrepancies in a nominal time period predetermined by the synchronization signal, for detection of the radiation of conversion events of the free-running current/frequency converters.

2. The radiation detector as claimed in claim 1, wherein in each radiation sensor, a separate current/frequency converter is at least one of arranged on or at the mount substrate and is integrated in the mount substrate and connected to the radiation sensor.

3. The radiation detector as claimed in claim 1, wherein the correction unit uses a recursive correction algorithm, by which the digital signals of each current/frequency converter are calculated using the following formula:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁, to the time difference between the start of the nominal time period and the start of the immediately preceding conversion event, and Δtᵢ to the time difference between the end of the nominal time period and the start of the immediately subsequent conversion event.

4. The radiation detector as claimed in claim 1, wherein the radiation sensors include photosensors.

5. The radiation detector as claimed in claim 4, wherein scintillators are arranged above the photosensors to convert incident X-ray radiation to light radiation.

6. The radiation detector as claimed in claim 5, wherein the scintillators are arranged and designed such that subareas between photosensitive surfaces of the photosensors are not covered by the scintillators.

7. The radiation detector as claimed in claim 6, wherein digital circuit parts and wiring for the evaluation electronics are essentially arranged under the subareas which are not covered, while analog circuit parts of the evaluation electronics are essentially arranged under areas which are covered by the scintillators.

8. The radiation detector as claimed in claim 1, wherein the correction unit is at least one of arranged on or at the mount substrate and is integrated in the mount substrate.

9. The radiation detector as claimed in claim 1, wherein the radiation sensors form a pixel array with total of m×n pixels, where m>10 and n>10.

10. A method for synchronized detection of radiation having a two-dimensional arrangement of radiation sensors using APS technology, in which analog signals from the radiation sensors are converted to digital signals, the method comprising:
using current/frequency converters for conversion and operating the converters in a free-running manner; and
correcting errors in the digital signals, caused by time discrepancies in a nominal time period, by calculation, for detection of the radiation from conversion events of the free-running current/frequency converters.

11. The method as claimed in claim 10, wherein each radiation sensor has an associated separate current/frequency converter.

12. The method as claimed in claim 10, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁ to the immediately preceding digital signal, Δn to a difference in the count of the current/frequency converter between the instantaneous signal and the immediately preceding signal, Δtᵢ₋₁ to the time difference between the start of the nominal time period and the start of the immediately preceding conversion event, and Δtᵢ to the time difference between the end of the nominal time period and the start of the immediately subsequent conversion event.

13. The radiation detector as claimed in claim 2, wherein the correction unit uses a recursive correction algorithm, by which the digital signals of each current/frequency converter are calculated using the following formula:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁, to the time difference between the start of the nominal time period and the start of the immediately preceding conversion event, and Δtᵢ to the time difference between the end of the nominal time period and the start of the immediately subsequent conversion event.

14. The radiation detector as claimed in claim 2, wherein the correction unit is at least one of arranged on or at the mount substrate and is integrated in the mount substrate.

15. The radiation detector as claimed in claim 2, wherein the radiation sensors form a pixel array with total of m×n pixels, where m>10 and n>10.

16. The radiation detector as claimed in claim 3, wherein the correction unit is at least one of arranged on or at the mount substrate and is integrated in the mount substrate.

17. The radiation detector as claimed in claim 3, wherein the radiation sensors form a pixel array with total of m×n pixels, where m>10 and n>10.

18. The method as claimed in claim 11, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁, to the time difference between the start of the nominal time period and the start of the immediately preceding conversion event, and Δtᵢ to the time difference between the end of the nominal time period and the start of the immediately subsequent conversion event.

19. The method of claim 10, wherein the method is for synchronized detection of X-ray radiation.

20. The method of claim 10, wherein the nominal time period is predetermined by a synchronization signal.

21. An apparatus for synchronized detection of radiation having a two-dimensional arrangement of radiation sensors using APS technology, the apparatus comprising:
means for converting analog signals from the radiation sensors to digital signals in a free-running manner; and
means for correcting errors in the digital signals, caused by time discrepancies in a nominal time, by calculation, for detection of the radiation from conversion events of the free-running means for converting.

22. The apparatus as claimed in claim 21, wherein each radiation sensor has an associated separate means for converting.

23. The apparatus as claimed in claim 21, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁ to the time difference between the start of the nominal time period and the start of the immediately preceding conversion event, and Δtᵢ to the time difference between the end of the nominal time period and the start of the immediately subsequent conversion event.

24. The apparatus as claimed in claim 22, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁ to the immediately preceding digital signal, Δn to a difference in the count of the current/frequency converter between the instantaneous signal and the immediately preceding signal, Δtᵢ₋₁ to the time difference between the start of the nominal time period and the start of the immediately preceding conversion event, and Δtᵢ to the time difference between the end of the nominal time period and the start of the immediately subsequent conversion event.

25. The apparatus as claimed in claim 21, wherein the nominal time period is predetermined by a synchronization signal.

26. A radiation detector, comprising:
a two-dimensional arrangement of radiation sensors using APS technology; and
evaluation electronics, the evaluation electronics including,
at least two free-running current/frequency converters for conversion of analog signals from the radiation sensors to digital signals, and
a correction unit for correction of errors in the digital signals, caused by time discrepancies in a nominal time period, for detection of the radiation from conversion events of the free-running current/frequency converters.

27. The apparatus as claimed in claim 26, wherein each radiation sensor has an associated separate converter.

28. The apparatus as claimed in claim 26, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁, to the time difference between the start of the nominal time period and the start of the immediately preceding conversion event, and Δtᵢ to the time difference between the end of the nominal time period and the start of the immediately subsequent conversion event.

29. The apparatus as claimed in claim 27, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁ to the time difference between the start of the nominal time period and the start of the immediately preceding conversion event, and Δtᵢ to the time difference between the end of the nominal time period and the start of the immediately subsequent conversion event.

30. The apparatus as claimed in claim 26, wherein the nominal time period is predetermined by a synchronization signal input to the evaluation electronics.

31. A radiation detector, comprising:
a two-dimensional arrangement of radiation sensors using APS technology; and
evaluation electronics including,
means for converting analog signals from the radiation sensors to digital signals, and
means for correcting errors in the digital signals, caused by time discrepancies in a nominal time period, for detection of the radiation from conversion events of the means for converting.

32. The apparatus as claimed in claim 31, wherein each radiation sensor has an associated separate means for converting.

33. The apparatus as claimed in claim 31, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁ to the time difference between the start of the nominal time period and the start of the immediately preceding conversion event, and Δtᵢ to the time difference between the end of the nominal time period and the start of the immediately subsequent conversion event.

34. The apparatus as claimed in claim 32, wherein the errors are corrected using the following recursive correction algorithm:
$${S}_{i} = \frac{Δ n τ - {S}_{i - 1} Δ {t}_{i - 1}}{τ - {Δ}_{i}} ,$$
where τ corresponds to the nominal time period, Sᵢ to the instantaneous digital signal, Sᵢ₋₁, to the immediately preceding digital signal, Δn to a difference in the count of the current/frequency converter between the instantaneous signal and the immediately preceding signal, Δtᵢ₋₁, to the time difference between the start of the nominal time period and the start of the immediately preceding conversion event, and Δtᵢ to the time difference between the end of the nominal time period and the start of the immediately subsequent conversion event.

35. The apparatus as claimed in claim 31, wherein the nominal time period is predetermined by a synchronization signal input to the evaluation electronics.
